(19) United States
(12) Patent Application Publication
(10) Pub. No.: US 2025/0362425 A1
(43) Pub. Date: Nov. 27, 2025

(54) METHODS AND SYSTEMS FOR GRAIN DENSITY AND POROSITY DETERMINATION FOR PLANNED WELLS

(71) Applicant: SAUDI ARABIAN OIL COMPANY, Dhahran (SA)

(72) Inventors: Chicheng Xu, Houston, TX (US); Mustafa Albahrani, West Lafayette, IN (US); Tao Lin, Katy, TX (US); Yaser Alzayer, Dhahran (SA); Weichang Li, Katy, TX (US); Ahmed Alnahwi, Dhahran (SA)

(73) Assignees: ARAMCO SERVICES COMPANY, Houston, TX (US); SAUDI ARABIAN OIL COMPANY, Dhahran (SA)

(21) Appl. No.: 18/670,818

(22) Filed: May 22, 2024

(51) Int. Cl. G01V 8/00; E21B 43/30; G06V 20/10

(52) U.S. Cl. CPC G01V 8/00; E21B 43/30; G06V 20/194; E21B 2200/20

(57) ABSTRACT

Methods and systems for updating a well plan for a planned well using a hyperspectral image of a well core obtained from the planned well. The method includes determining a distribution of mineral abundances for a plurality of minerals across the well core using the hyperspectral image and determining an image-derived distribution of grain density from the distribution of mineral abundances. The method further includes calibrating the image-derived distribution of grain density to obtain a calibrated distribution of grain density and determining a vertical profile of grain density across the well core using the calibrated distribution of grain density. In addition, the method includes determining a total porosity of the planned well using the vertical profile of grain density and updating using a well planning system, a portion of the planned well based on the total porosity.

### BACKGROUND

In the oil and gas industry, rock samples are routinely cored from drilled wells to measure rock properties such as grain density. Grain density is important for evaluating other reservoir properties such as total porosity and water saturation, both of which inform hydrocarbon volume estimation and reserve permeability. However, the grain density measured from cores is spatially limited to specific locations sampled from the core and is consequently discrete. Such measurements may not be representative of the entirety of the well or even the entirety of the core. This is particularly true for heterogeneous formations. Therefore, there exists a need for methods and systems capable of generating continuous profiles or maps of grain density distributions that are accurate, provide high spatial resolution over a range of scales, and enable robust characterization of porosity.

### SUMMARY

This summary is provided to introduce a selection of concepts that are further described below in the detailed description. This summary is not intended to identify key or essential features of the claimed subject matter, nor is it intended to be used as an aid in limiting the scope of the claimed subject matter.

Embodiments of the present disclosure generally relate to a method of updating a well plan for a planned well using a hyperspectral image of a well core obtained from the planned well. The method includes determining a distribution of mineral abundances for a plurality of minerals across the well core using the hyperspectral image and determining an image-derived distribution of grain density from the distribution of mineral abundances. The method further includes calibrating the image-derived distribution of grain density to obtain a calibrated distribution of grain density and determining a vertical profile of grain density across the well core using the calibrated distribution of grain density. In addition, the method includes determining a total porosity of the planned well using the vertical profile of grain density and updating using a well planning system, a portion of the planned well based on the total porosity.

Embodiments of the present disclosure generally relate to a system for updating a well plan for a planned well using a hyperspectral image of a well core obtained from the planned well. The system includes a computer configured to determine a distribution of mineral abundances for a plurality of minerals across the well core using the hyperspectral image and determine an image-derived distribution of grain density from the distribution of mineral abundances. The computer is further configured to calibrate the image-derived distribution of grain density to obtain a calibrated distribution of grain density and to determine a vertical profile of grain density across the well core using the calibrated distribution of grain density. In addition, the computer is configured to determine a total porosity of the planned well using the vertical profile of grain density. The system also includes a well planning system configured to update a portion of the planned well based on the total porosity.

Embodiments of the preset disclosure generally relate to a non-transitory computer-readable memory comprising computer-executable instructions stored thereon that, when executed on a processor, cause the processor to update a well plan for a planned well, using a hyperspectral image of a well core obtained from the planned well, by performing the following steps. The steps include determining a distribution of mineral abundances for a plurality of minerals across the well core using the hyperspectral image and determining an image-derived distribution of grain density from the distribution of mineral abundances. The steps further include calibrating the image-derived distribution of grain density to obtain a calibrated distribution of grain density and determining a vertical profile of grain density across the well core using the calibrated distribution of grain density. In addition, the steps include determining a total porosity of the planned well using the vertical profile of grain density and updating, using a well planning system, a portion of the planned well based on the total porosity.

Other aspects and advantages of the claimed subject matter will be apparent from the following description and the appended claims.

### BRIEF DESCRIPTION OF DRAWINGS

Specific embodiments of the disclosed technology will now be described in detail with reference to the accompanying figures. Like elements in the various figures are denoted by like reference numerals for consistency.

FIG. 1 depicts a drilling system in accordance with one or more embodiments.

FIG. 2 depicts a workflow in accordance with one or more embodiments.

FIG. 3A depicts a schematic diagram of a neural network in accordance with one or more embodiments.

FIG. 3B depicts a schematic diagram of a self-organizing map in accordance with one or more embodiments.

FIG. 4 depicts distribution of mineral abundances in accordance with one or more embodiments.

FIG. 5 depicts a distribution of mineral abundances and an image derived distribution of grain density in accordance with one or more embodiments.

FIG. 6 depicts a cross-plot in accordance with one or more embodiments.

FIG. 7 depicts plurality of measurements in accordance with one or more embodiments.

FIG. 8 depicts a flowchart in accordance with one or more embodiments.

FIG. 9 depicts a system in accordance with one or more embodiments.

### DETAILED DESCRIPTION

In the following detailed description of embodiments of the disclosure, numerous specific details are set forth in order to provide a more thorough understanding of the disclosure. However, it will be apparent to one of ordinary skill in the art that the disclosure may be practiced without these specific details. In other instances, well-known features have not been described in detail to avoid unnecessarily complicating the description.

Throughout the application, ordinal numbers (e.g., first, second, third, etc.) may be used as an adjective for an element (i.e., any noun in the application). The use of ordinal numbers is not to imply or create any particular ordering of the elements nor to limit any element to being only a single element unless expressly disclosed, such as using the terms “before,” “after,” “single,” and other such terminology. Rather, the use of ordinal numbers is to distinguish between the elements. By way of an example, a first element is distinct from a second element, and the first element may encompass more than one element and succeed (or precede) the second element in an ordering of elements.

It is to be understood that the singular forms “a,” “an,” and “the” include plural referents unless the context clearly dictates otherwise. Thus, for example, reference to “acoustic signal” includes reference to one or more of such acoustic signals.

Terms such as “approximately,” “substantially,” etc., mean that the recited characteristic, parameter, or value need not be achieved exactly, but that deviations or variations, including for example, tolerances, measurement error, measurement accuracy limitations and other factors known to those of skill in the art, may occur in amounts that do not preclude the effect the characteristic was intended to provide.

It is to be understood that one or more of the steps shown in the flowchart may be omitted, repeated, and/or performed in a different order than the order shown. Accordingly, the scope disclosed herein should not be considered limited to the specific arrangement of steps shown in the flowchart.

Although multiple dependent claims are not introduced, it would be apparent to one of ordinary skill that the subject matter of the dependent claims of one or more embodiments may be combined with other dependent claims.

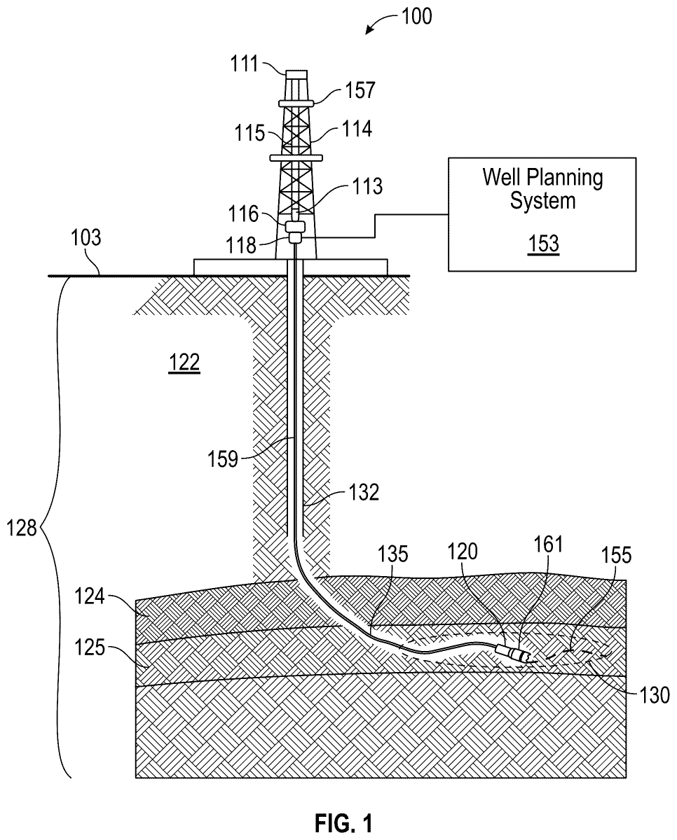

In the following description of FIGS. 1-9, any component described with regard to a figure, in various embodiments disclosed herein, may be equivalent to one or more like-named components described with regard to any other figure. For brevity, descriptions of these components will not be repeated with regard to each figure. Thus, each and every embodiment of the components of each figure is incorporated by reference and assumed to be optionally present within every other figure having one or more like-named components. Additionally, in accordance with various embodiments disclosed herein, any description of the components of a figure is to be interpreted as an optional embodiment which may be implemented in addition to, in conjunction with, or in place of the embodiments described with regard to a corresponding like-named component in any other figure.

Embodiments disclosed herein generally relate to systems and methods for determining the total porosity within a subsurface region traversed by a planned well in order to update a portion of the planned well. The porosity of a subsurface region is a valuable metric indicative of the possibility for storage hydrocarbons and other fluids. A greater porosity allows for a greater volume of retained fluid, and the amount of space available in a subsurface region is sometimes referred to as a fraction of void space. Porosity also directly affects permeability and consequently affects the efficiency of extraction operations. For example, regions of rock with greater porosity enable minimally obstructed flow of fluid and therefore provide for easier extraction. The porosity, and consequently the fraction of void space, the presence of hydrocarbons or other targeted resources, and the associated difficulty of extracting the subsurface resources varies between subsurface regions depending on the type of rock present.

Porosity is related to the bulk density of the subsurface region, the grain density of the rock in the subsurface region, and the density of the interspersed fluid contained therein. Bulk density and fluid density are often easily measured through a variety of techniques applied in well logging, including measurement of the attenuation of gamma rays, resistivity, as well as seismic and acoustic analysis. The grain density may be measured through detailed laboratory analysis of rocks obtained from the subsurface region of interest. The minerals that compose the rock each have a known density, and thus the analyses involve identifying which minerals are present as well as their abundance. However, minerology changes throughout subsurface regions, and the grain density that is measured is consequently a local measurement specific to the location that the sample was obtained from. Moreover, laboratory methods for measuring grain density are often destructive to the rock sample.

In accordance with one or more embodiments, a hyperspectral image of a well core obtained from a planned well may be obtained. Hyperspectral images may be thought of as a combination of both spectroscopy and standard digital imaging using a bandpass filter. Standard digital images often consist of a plurality of pixels organized in a rectangular grid where the value at each pixel represents a measured brightness (or luminosity, or flux). The brightness that is measured is defined by an imaging bandpass filter that restricts incoming light to a particular wavelength domain. A “color” image may be obtained by combining images from different filters. In this way, broadband imaging provides spectral information of imaged objects but only provides spectral resolution at a level of the range of wavelengths spanned by the filter in use. Spectroscopy aims to measure the brightness of a target as a function of wavelength on finer scales by dispersing the light. A variety of techniques may be employed, but most utilize either a prism, a diffraction grating, or a combination of the two (sometimes referred to as a “grism”). A hyperspectral image is an image where a spectrum is obtained at each position (or pixel), rather than a single measurement of brightness in one filter. A variety of techniques are known in the art of obtaining hyperspectral images. One example of a hyperspectral imaging device is a push broom scanner (or an along-track scanner), which operates by progressing an imaging spectrograph over a target region and projecting the dispersed light onto a detector. The imaging spectrograph restricts incoming light to a narrow field of view referred to as slit. At each position, a line (or small rectangular portion) of the target is analyzed according to the field of view provided by the slit. A spectrum is obtained across the entirety of the object by progressing (or scanning) the push broom scanner from one end of the target to the other.

Although description is provided above of hyperspectral scanning images, it is to be understood that the methods and systems of the present disclosure apply to hyperspectral images that are obtained without scanning. Techniques to obtain hyperspectral images are not limited to “scanning” per se. A hyperspectral image may be obtained by combining many images of a given target taken in many narrow imaging filters. Alternatively or in addition, techniques that obtain both spatial and spectral information simultaneously may be used such as computed tomographic imaging spectroscopy, fiber-reformatting imaging spectroscopy, and integral field spectroscopy.

Ultimately, a porosity of the planned well may be determined using the hyperspectral image of the well core, in accordance with one or more embodiments. As previously discussed, the porosity is a function of the bulk density, the fluid density, and the grain density. The bulk density and fluid density may be measured using standard well logging techniques. However, determining the porosity may require determining a distribution of mineral abundances across the well core, as each mineral contributes to the grain density differently. The distribution of mineral abundances for a plurality of minerals across the well core may be determined using the hyperspectral image.

The hyperspectral image typically spans the approximate extent of the well core. To reiterate, the hyperspectral image contains a spectrum at each position in the image and thus each position across the well core. Every mineral has a unique spectral signature, and the presence of a mineral (i.e., its classification and its abundance) are encoded within the hyperspectral image. An image-derived distribution of grain density may be determined from the distribution of mineral abundances determined from the hyperspectral image, for example, by comparing the abundance of a given mineral with its known density. The image-derived distribution of grain density may be calibrated using laboratory measurements of grain density from the same core, for example, using X-ray diffraction analysis. Once the grain density is determined and calibrated across the well core, a vertical profile of grain density across the well core may be determined. For example, in one or more embodiments, a predetermined spatial resolution may be desired (e.g., 0.5 feet), and the grain density may be binned (or sampled) according to this resolution and averaged in each bin. A total porosity of the planned well may thus be determined using the vertical profile of grain density. In accordance with one or more embodiments, a portion of the planned well may be updated using a well planning system based on the total porosity. For example, updating the planned well may involve updating the planned drilling path to avoid a region of low total porosity or to target a region of high total porosity. That is, the planned well may be updated target a subsurface region with a predetermined total porosity.

In accordance with one or more embodiments, FIG. 1 depicts a drilling system (100). As shown in FIG. 1, a wellbore (135) following the wellbore path (155) may be drilled by a drill bit (161) attached by a drill string (159) to a drilling rig (157) located on the surface of the earth. The drilling rig (157) may include framework, such as a derrick (114) to hold drilling machinery. A crown block (111) may be mounted at the top of the derrick (114), and a traveling block (113) may hang down from the crown block (111) by means of a cable (115) or drilling line. One end of the cable (115) may be connected to a drawworks (not shown), which is a reeling device that may be used to adjust the length of the cable (115) so that the traveling block (113) may move up or down the derrick (114).

A top drive (116) provides clockwise torque via the drive shaft (118) to the drill string (159) in order to drill the wellbore (135). The drill string (159) may comprise a plurality of sections of drillpipe attached at an uphole end to the drive shaft (118) and downhole to a bottomhole assembly (“BHA”) (120). The BHA (120) may be composed of a plurality of sections of heavier drillpipe and one or more measurement-while-drilling (“MWD”) tools configured to measure drilling parameters. Measured drilling parameters may include torque, weight-on-bit, drilling direction, temperature, etc. Additionally, the BHA may have one or more logging tools (e.g., logging-while-drilling (“LWD”)) configured to measure parameters of the rock surrounding the wellbore (135), such as electrical resistivity, density, sonic propagation velocities, gamma-ray emission, etc. MWD tools and logging tools may include sensors and hardware to measure downhole drilling parameters, and these measurements may be transmitted to the surface (103) using any suitable telemetry system known in the art. The BHA (120) and the drill string (159) may include other drilling tools known in the art but not specifically shown.

The drilling system (100) may be configured to communicate with other systems in the well environment. The drilling system (100) may control at least a portion of a drilling operation by providing controls to various components of the drilling operation. In one or more embodiments, the drilling system (100) may receive well data from one or more sensors and/or logging tools arranged to measure controllable parameters of the drilling operation. During operation of the drilling system (100), the well data may include mud properties, flow rates, drill volume and penetration rates, rock physical properties, etc. To start drilling, or “spudding in” the well, the hoisting system lowers the drill string (159) suspended from the derrick (114) towards the planned surface location of the wellbore (135). An engine or electric motor may be used to supply power to the top drive (116) to rotate the drill string (159) through the drive shaft (118). The weight of the drill string (159) combined with the rotational motion enables the drill bit (161) to bore the wellbore (135).

The wellbore (135) may traverse a plurality of overburden (122) layers and one or more formations (124) to a potential hydrocarbon reservoir (125) within the subsurface (128), and specifically to a drilling target (130) within the potential hydrocarbon reservoir (125). The wellbore path (155) may be a curved or a straight trajectory. All or part of the wellbore path (155) may be vertical, and some parts of the wellbore path (155) may be deviated or have horizontal sections. One or more portions of the wellbore (135) may be cased with casing (132) in accordance with a well plan.

The well plan may be generated based on any available information at the time of planning. A well plan may be constructed using a geophysical model or a geomechanical models encapsulating subterranean stress conditions, or both. Alternatively, or in addition, the well plan may account for the trajectory of any existing wellbores (which it may be desirable to avoid), and the existence of other drilling hazards, such as shallow gas pockets, over-pressure zones, and active fault planes. The drilling system (100) may be used to drill the wellbore (135) along the planned wellbore path (155) to access the drilling target (130) in the potential hydrocarbon reservoir (125). In accordance with one or more embodiments, the well plan may be designed to target a subsurface region of predetermined porosity. Subsurface rock with high porosity (e.g., greater than 10%, 15%, or 20% porosity) are more likely to contain hydrocarbons (or oil and gas) simply because a greater porosity, by definition, provides greater storage capacity for subsurface fluids. In addition, porosity and permeability are directly correlated further motivating targeting subsurface regions with high porosity. Further methods known in the art for reserve estimation may be considered in addition to targeting a subsurface region of predetermined porosity.

The well planning system (153) is used to develop the well plan. The well planning system (153) may help drilling engineers in designing casing strings and selecting appropriate tubulars based on the wellbore conditions, planned drilling operations, and regulatory requirements. The well planning system (153) may consider factors such as pressure, temperature, well depth, formation properties, and casing load capacity. Furthermore, the well planning system (153) may perform torque and drag analysis to evaluate the forces and stresses acting on the drill string (159) during drilling operations. This analysis helps in identifying potential issues such as differential sticking, buckling, or limitations in the drilling equipment. The well planning system (153) may have the capability to integrate real-time drilling data, such as downhole measurements, drilling parameters, and formation evaluation results. This integration allows engineers to monitor the drilling progress, make on-the-fly adjustments to the well plan, optimize drilling efficiency, and maintain drilling safety. The well planning system (153) may further allow drilling engineers to visualize and interact with wellbore data in a 3D environment. The well planning system (153) may provide a graphical representation of the planned well trajectory, existing well paths, geological formations, and potential hazards. Furthermore, the well planning system (153) may provide tools for generating reports, exporting data, and documenting drilling plans and decisions. These reports can be shared with regulatory agencies, drilling contractors, and other stakeholders to ensure alignment and compliance throughout the drilling lifecycle.

In accordance with one or more embodiments, a target porosity may be predetermined and specified by a well plan. However, the porosity of the subsurface region traversed by the wellbore may not necessarily be known at the time of drilling, or it may not be known in extensive detail. Cores obtained from the well may be used to determine porosity, and during a drilling operation, a well core may be obtained, for example, using a coring drill bit. As described previously, porosity is related to the bulk density of a subsurface rock, the density of fluid contained therein, and the grain density of the subsurface region. Accurate determination of porosity often requires extensive laboratory analysis of samples from the core that may be destructive to the samples. For example, a sample (or “plug”) may be obtained from a drilled core, and the bulk volume may be measured simply by quantifying the sample's geometrical dimensions or through liquid displacement. Measuring grain volume typically requires crushing the core sample and measuring a liquid displacement when immersing the crushed sample in a fluid of known volume. Moreover, such methods are spatially restricted to the region of the core from which the sample originated. Accordingly, the porosity that is measured is not necessarily representative of the entire core. Methods and systems described in the present disclosure improve upon these deficiencies.

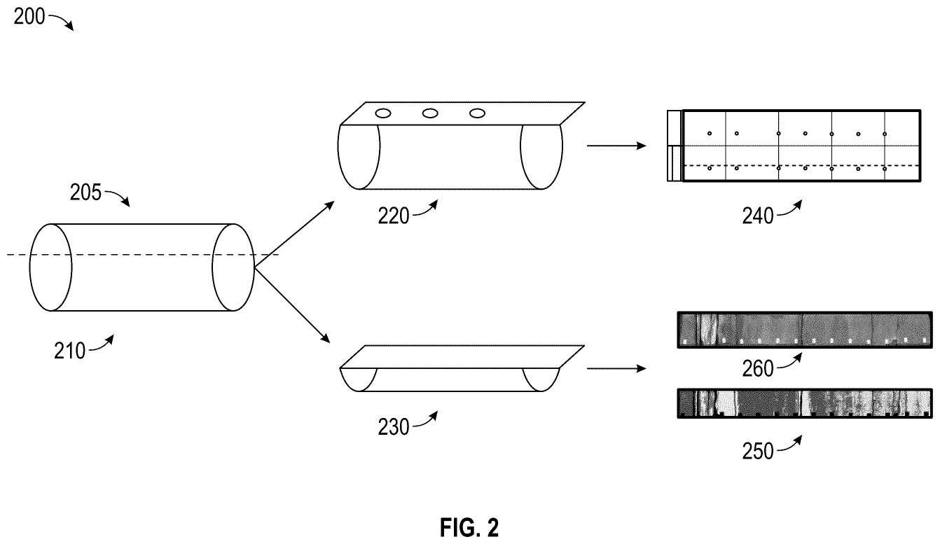

FIG. 2 depicts a preliminary workflow (200) for the initial stages of determining a total porosity of a planned well using a hyperspectral image in accordance with one or more embodiments. As described above, well cores (205) are often obtained in drilled wells, including those that are actively being planned. To obtain different types of samples from the well core, the first operation of the preliminary workflow (200) may include core slicing (210). Core slicing (210) involves cutting (or dividing) the well core (205) into two separate components.

The well core (205) may be sliced according to any proportion, for example, creating two components with sizes of ¼ the initial core and ¾, respectively. However, alternative proportions may be used, for example, ⅕ and ⅘ proportions, ½ and ½ proportions, or any other suitable proportions. Cylindrical samples known as plugs may be obtained from one of the two components of the core (205) during core plugging (220). The plugs obtained from core plugging (220) may then be used for core analysis (240) in which the grain density is measured and X-ray diffraction (XRD) measurements are obtained. Grain density may be measured from the plugs in a laboratory according to any method known in the art, including the methods described above. Such a grain density measurement may be referred to as a “laboratory-derived” grain density. XRD may be used to identify minerals and their abundances within the plugs. XRD involves measuring the diffraction pattern of incident X-rays upon a crystalline structure, such as a mineral, caused by the atomic structure of crystalline structures. Each mineral, by virtue of its unique composition, creates a unique XRD pattern.

The component of the well core (205) that is not used during core plugging (220) may be used for core scanning (230). Core scanning (230) may involve obtaining both a standard color (or Red-Green-Blue) RGB image (260) of the well core for visual interpretation of the well core in optical wavelengths (i.e., wavelengths between 400-700 nm). As a non-limiting example, the spatial resolution of the RGB image (260) may be, for example, approximately 120 microns, however alternative spatial resolutions are suitable. In addition, core scanning (230) may include obtaining a hyperspectral image (250). To reiterate, the hyperspectral image contains a digital image defined by a grid of pixels, where each pixel contains a spectrum. Here, a spectrum simply refers to a description of the energy or intensity of electromagnetic radiation as a function of wavelength. A spectrum may also contain absorption features, which show an absence or decrease in reflected or emitted light at a specific wavelength. The hyperspectral image may contain spectra that span any desired and technically accessible range of wavelengths. In accordance with one or more embodiments, the spectra may span short-wave infrared (SWIR) wavelengths between 1000 nm to 2500 nm, long-wave infrared (LWIR) wavelengths between 7700 nm and 12,300 nm, or both SWIR and LWIR wavelengths. Hyperspectral cameras can vary in their properties and capabilities, and hyperspectral cameras may be combined to obtain the hyperspectral image. As a non-limiting example, a hyperspectral camera may be configured to operate at SWIR wavelengths with a spectral resolution of approximately 9 nm and may be capable of obtaining approximately 288 bands of data sampling the SWIR wavelengths at a rate of 1 sample per 5.6 nm. As another non-limiting example, a hyperspectral camera may be configured to operate at LWIR wavelengths with a spectral resolution of approximately 100 nm and may be capable of obtaining approximately 96 bands of data sampling LWIR wavelengths at a rate of 1 sample per 48 nm. The spatial resolution of hyperspectral camara may be approximately 0.4 mm per pixel, however, alternative spatial resolutions may be suitable. Again, the properties of hyperspectral cameras may vary significantly, and the description above is provided solely for illustrative purposes and is not to be considered limiting.

In accordance with one or more embodiments, a distribution of mineral abundances for a plurality of minerals may be determined across the well core using the hyperspectral image. A plurality of minerals is virtually always present in a core sample (although this need not be true for application of the methods and systems of the present disclosure). Due to both their unique chemical and crystalline structure, minerals exhibit unique spectral features or spectral signatures. By comparing spectral response from the hyperspectral image with the known spectral features of different minerals, each mineral can be identified. A greater abundance of a particular mineral may also present a stronger spectral feature. Accordingly, the pixels of the hyperspectral image, each containing a spectrum, may be analyzed to identify which minerals are present as well as their relative abundance to consequently form a distribution of mineral abundances. That is, the distribution of mineral abundances describes the minerals that are present and their abundance with respect to one-another.

In one or more embodiments, the distribution of mineral abundances for a plurality of minerals is determined using a machine learning method. Machine learning (ML), broadly defined, is the extraction of patterns and insights from data. The phrases “artificial intelligence”, “machine learning”, “deep learning”, and “pattern recognition” are often convoluted, interchanged, and used synonymously throughout the literature. This ambiguity arises because the field of “extracting patterns and insights from data” was developed simultaneously and disjointedly among a number of classical arts like mathematics, statistics, and computer science. For consistency, the term machine learning (ML), will be adopted herein, however, one skilled in the art will recognize that the concepts and methods detailed hereafter are not limited by this choice of nomenclature.

Machine learning (ML) model types may include, but are not limited to, neural networks, decision trees, random forests, support vector machines, generalized linear models, and Bayesian regression. ML model types are usually associated with additional “hyperparameters” which further describe the model. For example, hyperparameters providing further detail about a neural network may include, but are not limited to, the number of layers in the neural network, choice of activation functions, inclusion of batch normalization layers, and regularization strength. The selection of hyperparameters surrounding a model is referred to as selecting the model “architecture.” Generally, multiple model types and associated hyperparameters are tested and the model type and hyperparameters that yield the greatest predictive performance on a hold-out set of data is selected.

A variety of machine learning methods or model-types may be used to determine the distribution of mineral abundances for a plurality of minerals across the well core using the hyperspectral image. For simplicity, the following description makes reference to a “machine learning model” (hereafter, the ML model), although it is to be understood that the methods and systems of the present disclosure are not limited to the use of one specific ML model. The goal of the ML model is to both identify which minerals are present in the hyperspectral image and estimate their relative abundance.

Before deployment, the ML model is trained using previously acquired, or historic, modelling data, in accordance with one or more embodiments. The modelling data is composed of observed and measured (or otherwise estimated or simulated) ML model inputs and associated outputs (sometimes referred to as a “target”). In supervised learning, training outputs or targets are labeled to give instruction to the ML model to indicate the desired (or correct) output for a given input. Unsupervised learning methods do not require labeled instruction but instead typically rely on meeting some other predetermined criterion or criteria. Greater detail will be given below in the context of a self-organizing map (SOM), which is a particular type of machine learning model that uses unsupervised learning. For supervised learning, the structure of the ML model inputs during training should closely resemble the inputs the ML model may encounter during deployment. For example, in determining the distribution of mineral abundances, the ML model training inputs may include hyperspectral images of well cores, while the training outputs (or targets) may be laboratory measurements for the same samples that identify the minerals present and their abundances.

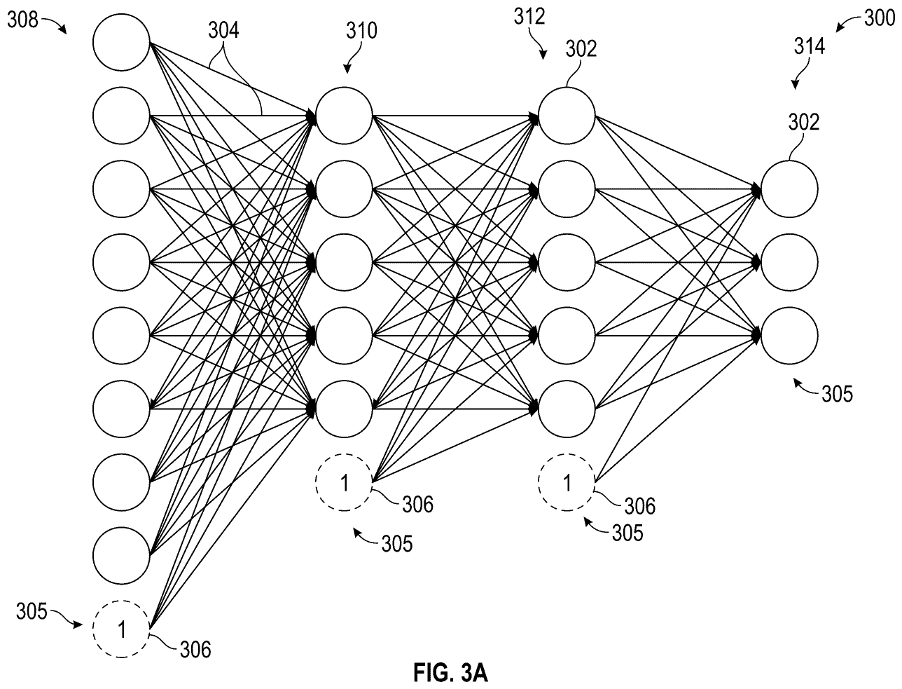

In accordance with one or more embodiments, the ML model that is used to determine the distribution of mineral abundances for a plurality of minerals across the well core, using the hyperspectral image, is a neural network. A diagram of a neural network is shown in FIG. 3A. At a high level, a neural network (300) may be graphically depicted as being composed of nodes (302), where here any circle represents a node, and edges (304), shown here as directed lines. The nodes (302) may be grouped to form layers (305). FIG. 3A displays four layers (308, 310, 312, 314) of nodes (302) where the nodes (302) are grouped into columns, however, the grouping need not be as shown in FIG. 3A. The edges (304) connect the nodes (302). Edges (304) may connect, or not connect, to any node(s) (302) regardless of which layer (305) the node(s) (302) is in. That is, the nodes (302) may be sparsely and residually connected. A neural network (300) will have at least two layers (305), where the first layer (308) is considered the “input layer” and the last layer (314) is the “output layer.” Any intermediate layer (310, 312) is usually described as a “hidden layer”. A neural network (300) may have zero or more hidden layers (310, 312) and a neural network (300) with at least one hidden layer (310, 312) may be described as a “deep” neural network or as a “deep learning method.” In general, a neural network (300) may have more than one node (302) in the output layer (314). In this case the neural network (300) may be referred to as a “multi-target” or “multi-output” network.

Nodes (302) and edges (304) carry additional associations. Namely, every edge is associated with a numerical value. The edge numerical values, or even the edges (304) themselves, are often referred to as “weights” or “parameters.” While training a neural network (300), numerical values are assigned to each edge (304). Additionally, every node (302) is associated with a numerical variable and an activation function. Activation functions are not limited to any functional class, but traditionally follow the form:

$$A = f ( {\sum }_{i ∈ ( incoming )} [ {( node value )}_{i} {( edge value )}_{i} ] ) , \qquad ( 1 )$$

where i is an index that spans the set of “incoming” nodes (302) and edges (304) and ƒ is a user-defined function. Incoming nodes (302) are those that, when viewed as a graph (as in FIG. 3A), have directed arrows that point to the node (302) where the numerical value is being computed. Some functions for ƒ may include the linear function ƒ(x)=x, sigmoid function

$$f ( x ) = \frac{1}{1 + {e}^{- x}} ,$$

and rectified linear unit function ƒ(x)=max(0,x), however, many additional functions are commonly employed. Every node (302) in a neural network (300) may have a different associated activation function. Often, as a shorthand, activation functions are described by the function ƒ by which it is composed. That is, an activation function composed of a linear function ƒ may simply be referred to as a linear activation function without undue ambiguity.

When the neural network (300) receives an input, the input is propagated through the network according to the activation functions and incoming node (302) values and edge (304) values to compute a value for each node (302). That is, the numerical value for each node (302) may change for each received input. Occasionally, nodes (302) are assigned fixed numerical values, such as the value of 1, that are not affected by the input or altered according to edge (304) values and activation functions. Fixed nodes (302) are often referred to as “biases” or “bias nodes” (306), displayed in FIG. 3A with a dashed circle.

In some implementations, the neural network (300) may contain specialized layers (305), such as a normalization layer, or additional connection procedures, like concatenation. One skilled in the art will appreciate that these alterations do not exceed the scope of this disclosure.

As noted, the training procedure for the neural network (300) comprises assigning values to the edges (304). To begin training, the edges (304) are assigned initial values. These values may be assigned randomly, assigned according to a prescribed distribution, assigned manually, or by some other assignment mechanism. Once edge (304) values have been initialized, the neural network (300) may act as a function, such that it may receive inputs and produce an output. As such, at least one input is propagated through the neural network (300) to produce an output. Recall, that a given data set will be composed of inputs and associated target(s), where the target(s) represent the “ground truth,” or the otherwise desired output. In the most general sense, the input of the neural network is the hyperspectral image while the target is the distribution of mineral abundances (given, for example, as a list of individual minerals and their respective relative abundances). In practice, a single input may be the spectrum contained by a single pixel of the hyperspectral image and the target is the true identity of the mineral located therein as well as its abundance. Recall that in the preliminary workflow (200) described above and depicted in FIG. 2, core analysis (240) includes measurement of grain density and X-ray diffraction (XRD). XRD measurements may be used to accurately identify minerals and thus can provide the necessary training labels for training a neural network. However, in order to use XRD measurements for training a neural network to identify minerals from a hyperspectral image, XRD measurements should be obtained for the same samples that are targeted in the hyperspectral image. Thus, a training input may consist of a spectrum from a single pixel of the hyperspectral image paired with the known mineral present, and its abundance, identified through XRD characterization.

Returning to FIG. 3A, the neural network (300) output is compared to the associated input data target(s). The comparison of the neural network (300) output to the target(s) is typically performed by a so-called “loss function;” although other names for this comparison function such as “error function,” “misfit function,” and “cost function” are commonly employed. Many types of loss functions are available, such as the mean-squared-error function, however, the general characteristic of a loss function is that the loss function provides a numerical evaluation of the similarity between the neural network (300) output and the associated target(s). The loss function may also be constructed to impose additional constraints on the values assumed by the edges (304), for example, by adding a penalty term, which may be physics-based, or a regularization term. Generally, the goal of a training procedure is to alter the edge (304) values to promote similarity between the neural network (300) output and associated target(s) over the data set. Thus, the loss function is used to guide changes made to the edge (304) values, typically through a process called “backpropagation.”

While a full review of the backpropagation process exceeds the scope of this disclosure, a brief summary is provided. Backpropagation consists of computing the gradient of the loss function over the edge (304) values. The gradient indicates the direction of change in the edge (304) values that results in the greatest change to the loss function. Because the gradient is local to the current edge (304) values, the edge (304) values are typically updated by a “step” in the direction indicated by the gradient. The step size is often referred to as the “learning rate” and need not remain fixed during the training process. Additionally, the step size and direction may be informed by previously seen edge (304) values or previously computed gradients. Such methods for determining the step direction are usually referred to as “momentum” based methods.

Once the edge (304) values have been updated, or altered from their initial values, through a backpropagation step, the neural network (300) will likely produce different outputs. Thus, the procedure of propagating at least one input through the neural network (300), comparing the neural network (300) output with the associated target(s) with a loss function, computing the gradient of the loss function with respect to the edge (304) values, and updating the edge (304) values with a step guided by the gradient, is repeated until a termination criterion is reached. Common termination criteria are: reaching a fixed number of edge (304) updates, otherwise known as an iteration counter; a diminishing learning rate; noting no appreciable change in the loss function between iterations; reaching a specified performance metric as evaluated on the data or a separate hold-out data set. Once the termination criterion is satisfied, and the edge (304) values are no longer intended to be altered, the neural network (300) is said to be “trained.”

In accordance with one or more embodiments, the ML model that is used to determine the distribution of mineral abundances for a plurality of minerals across the well core, using the hyperspectral image, is a self-organizing map (SOM). Determining the distribution of mineral abundances may involve classifying the spectral response from the hyperspectral image using the SOM. FIG. 3B depicts a SOM (350). A SOM (350) is a type of neural network, similar to the neural network (300) described above and depicted in FIG. 3A. However, SOMs (350) perform via unsupervised learning in contrast to the neural network (300) of FIG. 3A. SOMs (350) are often used to investigate parameter spaces with many dimensions or variables through a technique referred to as dimensional reduction. In short, SOMs (350) are generally used to find a two-dimensional representation of parameter space represented by a number of dimensions P (where typically P>2). Objects that are more similar or have correlations in the P-dimensional parameter space will be located more closely to one another in the two-dimensional representation as SOMs (350) preserve the topology of the P-dimensional space. Once the mapping between the P-dimensional parameter space and the two-dimensional surface is known, the mapping may be used to visually represent any of the objects' values or features in the P-dimensional parameter space. Further, the mapping may be used to visually represent features that are associated with the objects but were not in the P-dimensional parameter space at the time of training. Assuming that the P-dimensional parameter space is sufficient to characterize each object, the mapping will also show that objects with similar features not included in the P-dimensional parameter space at the time of training remain proximate to each other, or clustered together.

A SOM (350) is characterized by an input vector (358). The length of the input vector (358) corresponds to the number of dimensions of the parameter space being modeled. For example, consider an object moving in three-dimensional space and through time. Such an object may be described in a four-dimensional parameter space and thus have an input vector (358) of length equal to four. As another example, consider an object that has been observed through digital imaging in three different bandpass filters. The brightness of the object in each filter may be considered a dimension of the parameter space, resulting in an input vector (358) of length equal to three. The input vector (358) is composed of nodes (i.e., input nodes), and each node in the input vector (358) contains as many values as are present to be analyzed. In the example of the hyperspectral image, every input node may represent a different sample of wavelength and, and every node may therefore contain as many measurements of brightness or intensity as there are pixels. Continuing the notation from above, it may be said that the input vector has a length of P where P is the dimensionality of the input data. Each input node in the input vector (358) is fully connected with every output node (365) in an output layer. The collection of output nodes (365) collectively form a feature map (364) which is the two-dimensional representation of the P-dimensional parameter space of the input vector (358). The number of output nodes (365) in the feature map (364) is a hyperparameter selected by a user.

As with the neural network (300), the connections between nodes are defined by weights. In a SOM (350), typically only two layers of nodes are present (i.e., the input vector (358) and the feature map (364)). The connections between the input vector (358) and the output nodes (365) in the feature map (364) are formed by weights together creating a weight matrix (354). The weights of a SOM (350) differ in their function compared to the weights of a neural network (300). In a SOM (350), the weights of one output node (365) essentially define the mapping between the output node (365) and the input vector (358). That is, the weight of each output node (365) defines its hypothetical position in the P-dimensional input vector (358). Thus, the weights of one output node (365) may be thought of as a coordinate which connects the two-dimensional feature map (364) to the P-dimensional input vector (358). Collectively, the weight matrix (354) defines the mapping for all of the output nodes (365) in the feature map (364) and the input vector (358). Following the notion of weights as coordinates, training a SOM (350) consists of updating the weights in the weight matrix (354) such that the distances between each output node (365) and the values of nodes in the input vector (358) are minimized in aggregate.

Training a SOM (350) includes the following general steps. First, the weights are initialized with values predetermined by a user. The initial values for the weights may be random or determined according to any method known the art. For example, a popular method for initializing weights in a SOM (350) is to sample values evenly from subspace spanned by the largest principal component eigenvectors. After initialization, one value from each of the input nodes in the input vector (358) is selected and the corresponding “best matching unit” (or BMU) is identified in the feature map (364). The BMU is the output node (365) with the smallest distance (recall that the weights of an output node (365) define a coordinate in P-dimensional space) to the selected value from the input vector (358). The distance may be measured using the Euclidean distance metric or another distance metric of choice. A key feature of SOMs (350) is that nodes proximate to one another influence each other such that they respond similarly to inputs of a given type, similar to how proximate neurons in the brain respond to stimuli of a given type. Once the BMU is found, a “neighborhood function” is used to select output nodes (365) in the feature map (364) that are close to the BMU. The size defined by the neighborhood function is another hyperparameter selected by the user. Finally, all of the output nodes (365) selected by the neighborhood function have their weights updated. The weight of an output node (365) node may be updated using the equation:

$${W}_{v} ( s + 1 ) = {W}_{v} ( s ) + θ ( u , v , s ) \cdot α ( s ) \cdot ( D ( t ) - {W}_{v} ( s ) ) . \qquad ( 2 )$$

Here, Wᵥ(s) is the weight of the output node (365) v at iteration s of the training, θ(u, v, s) is the neighborhood function which takes as inputs the index u representing the BMU as well as v and s, α(s) is the learning rate, and D(t) is the collection of values in the input vector (358) indexed by t. As can be seen, both the learning rate a(s) and neighborhood function θ(u, v, s) are functions of the iteration number and consequently may change with each iteration. Often, both the learning rate and neighborhood function decrease with each iteration, forcing changes to grow smaller over time and selecting fewer local output nodes (365) to be updated. Typically, the weights are updated iteratively for a number of iterations N where s<N, or once another predefined criterion is met.

In accordance with one or more embodiments, a SOM (350) may be used to identify minerals and their abundances by classifying the spectral response of a hyperspectral image as follows. Briefly, a SOM (350) may be used to analyze each pixel of a hyperspectral image, where each pixel contains a spectrum. A single hyperspectral image may consist of many hundreds of pixels. Thus, the length of the input vector (358) and the P-dimensional parameter space of a single pixel from the hyperspectral image may contain as many dimensions as there are samples in wavelengths. For example, recall that in a SWIR hyperspectral image, in one or more embodiments, every pixel may have as many as 288 samples in wavelength, while in a LWIR hyperspectral image, every pixel may have as many as 96 samples in wavelength. Consequently, the parameter space of a pixel combining both the SWIR and LWIR data may have 384 dimensions. The result of processing such a hyperspectral image with a SOM (350) is a two-dimensional mapping that represents this 384-dimensional parameter space and has grouped similar pixels (or spectra) together. Every pixel (more precisely, every pixel's spectrum) activates an output node (365) in the feature map (364) and is thus classified. Pixels (or spectra) that are similar to each other activate spatially proximate output nodes (365) in the feature map. Finally, using the mapping provided by the SOM (350), the mineral abundance and type that has been obtained from XRD measurements (e.g., during core analysis (240) in the preliminary workflow (200)) may be visually represented on the feature map (364). Accordingly, the mineral type and abundance of a mineral imaged in a given pixel may be determined simply by its location in the feature map (364). With the trained SOM (350), any hyperspectral image of a well core can thus be readily converted into a map of mineral type and abundance or a distribution of mineral abundances for the plurality of minerals present by classifying the spectral response of the hyperspectral image.

It is to be understood that the above presents only a brief introduction to SOMs and is not intended to be exhaustive. A person of ordinary skill in the art will appreciate that many changes can be made to the SOM (350) without departing from the scope of this disclosure. Further, while embodiments discussing ML model type have mostly focused on artificial neural networks and self-organizing maps, one skilled in the art will appreciate that this process, of identifying or classifying the mineral abundances for a plurality of minerals across a well core using a hyper spectral image, is not limited to the listed ML models. ML models such as random forests, support vector machines, or non-parametric methods such as K-nearest neighbors, K-means clustering, and Gaussian mixtures may be readily inserted into this framework and do not depart from the scope of this disclosure. In addition, a person of ordinary skill in the art will appreciate that embodiments of the present disclosure include computational techniques that do not use ML models. That is, in one or more embodiments, the distribution of mineral abundances may be determined using a computational technique that uses, for example, an empirical look-up table of mineral spectra.

Additional steps of data pre-processing may be included in the determination of a distribution of mineral abundances using the hyperspectral image, without limitation. Pre-processing may include activities such as, numericalization, filtering and/or smoothing of the data, scaling (e.g., normalization) of the data, feature selection, outlier removal (e.g., z-outlier filtering) and feature engineering. Feature selection includes identifying and selecting a subset of operation data with the greatest discriminative power with respect to predicting mineral type and abundance. For example, in one embodiment, discriminative power may be quantified by calculating the strength of correlation between wavelengths of the hyperspectral image and mineral type. Consequently, in some embodiments, not all of the wavelength samples contained by the hyperspectral image need be passed to the ML model. Feature engineering encompasses combining or manipulating the input data to create derived quantities. The derived quantities can be processed by the ML model. For example, the hyperspectral image may be processed by one or more “basis” functions such as a polynomial basis function or a radial basis function. In some embodiments, the hyperspectral image is passed to the ML model without pre-processing. Many additional pre-processing techniques exist such that a person of ordinary skill in the art would not interpret those listed here as a limitation on the present disclosure.

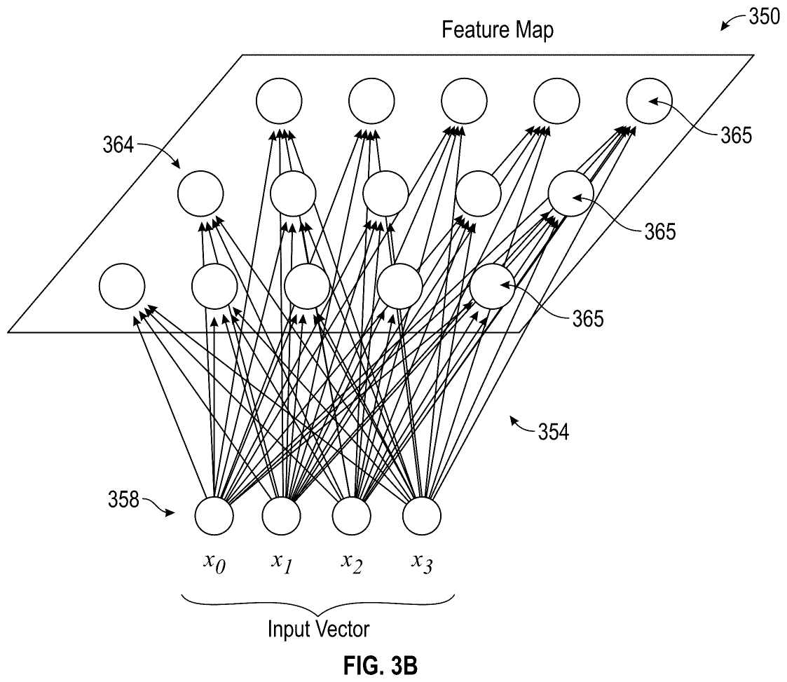

FIG. 4 depicts a hyperspectral image that has been converted into a distribution of mineral abundances (400) for a plurality of minerals (405). More specifically, FIG. 4 depicts a hyperspectral image in which each pixel has been classified as representing a given mineral (or a combination of minerals). The distribution of mineral abundances (400) may be obtained or determined from the hyperspectral image using any of the methods described above, for example, using a SOM. The plurality of minerals (405) are readily identified in the distribution of mineral abundances (400), including quartz-kaolinite (410), quartz (420), calcite-quartz (430), other illite (440), calcite (450), and calcite-illite (460). The list of minerals displayed (410-460) as part of the plurality of minerals (405) is not exhaustive and is only used for illustration. Other minerals not listed may be present and identified in hyperspectral images, for example dolomite, feldspar, plagioclase, mica, kaolinite (clay), and chlorite (clay).

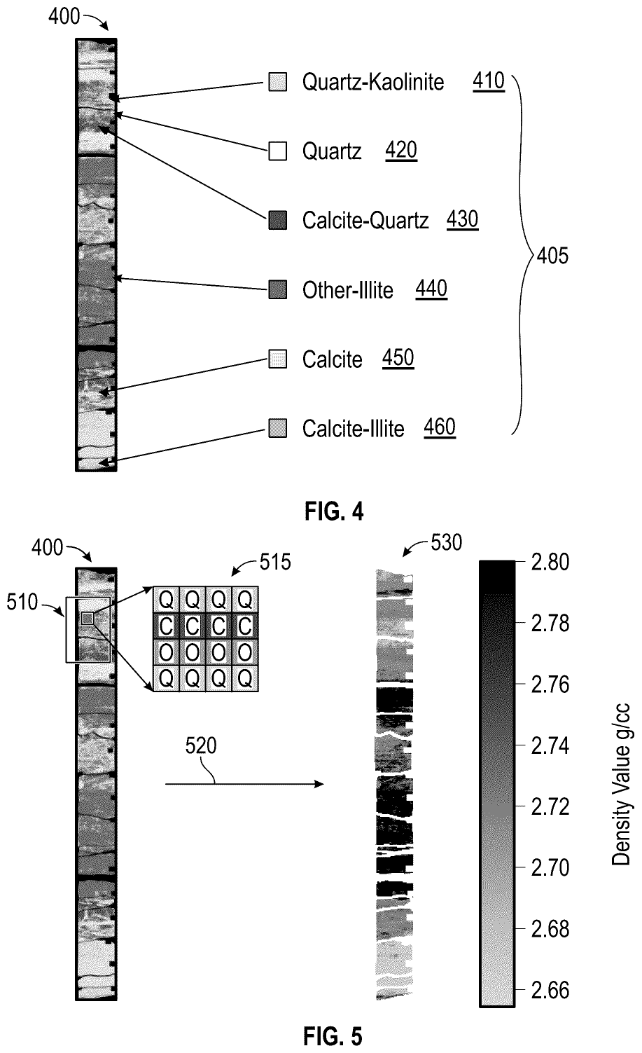

As depicted in FIG. 5, an image-derived distribution of grain density (530) may be determined from the distribution of mineral abundances (400). This is made possible because there is a direct relationship between a mineral's type and its abundance and its corresponding grain density (530). That is, the image-derived distribution of grain density (530) may be determined by a modification (520) of the distribution of mineral abundances (400). More specifically, the image-derived distribution of grain density (530) may be determined by modifying the distribution of mineral abundances according to a known density of each mineral in the plurality of minerals. In one or more embodiments, a window function (510) is used to group pixels in the distribution of mineral abundances (400) and thus select a subset of the plurality of minerals (515). The window function (510) is moved across the distribution of mineral abundances (400), and at each step, the following equation is used to calculate the image-derived grain density within the window function (510):

$${ρ}_{grain} = {\sum }_{i} \frac{{C}_{i}}{{C}_{t}} {ρ}_{i} . , \qquad ( 3 )$$

Here, ρ_{grain} is the grain density within the window function (510), Cᵢ is the number of pixels of mineral type i within the window function (510), ρᵢ is the known density of the mineral of type i, and Cₜ is the total number of pixels within the window function. The summation is performed over all of the types of minerals present within the window function (510), or for every mineral in the subset of the plurality of minerals (515). Consider quartz (420), for example. The number of pixels in the window function (510) corresponding to quartz (420), C_{quartz} is counted as well as the total number of pixels defined by the window function (510), Cₜ. The volumetric concentration of quartz (420), or its abundance, is then approximated by the ratio of the number of pixels in the window function (510) that contain quartz (420) and the total number of pixels in the window function (510), C_{quartz}/Cₜ. Finally, the contribution to the grain density given by quartz is obtained by multiplying C_{quartz}/Cₜ by the known density of quartz, ρ_{quartz}, which is 2.65 g/cm³. This process is repeated for every mineral in the window function (510) for every mineral in the subset of the plurality of minerals (515), and the window function moves to another location where the process is again repeated for every mineral. Table 1 provided below lists known densities (or ranges of densities) for common minerals.

TABLE 1

| Mineral type | Density (g/cm³) |
|---|---|
| Quartz | 2.65 |
| Potassium Feldspar | 2.55-2.63 |
| Plagioclase | 2.62-2.76 |
| Calcite | 2.71 |
| Dolomite | 2.84-2.86 |
| Pyrite | 4.95-5.10 |
| Analcite | 2.24-2.29 |
| Clinoptilolite | 2.15-2.16 |
| Kaolinite (clay) | 2.60-2.63 |
| Chlorite (clay) | 2.60-3.30 |
| Illite (clay) | 2.60-2.90 |
| Montmorillonite (clay) | 1.70-2.00 |

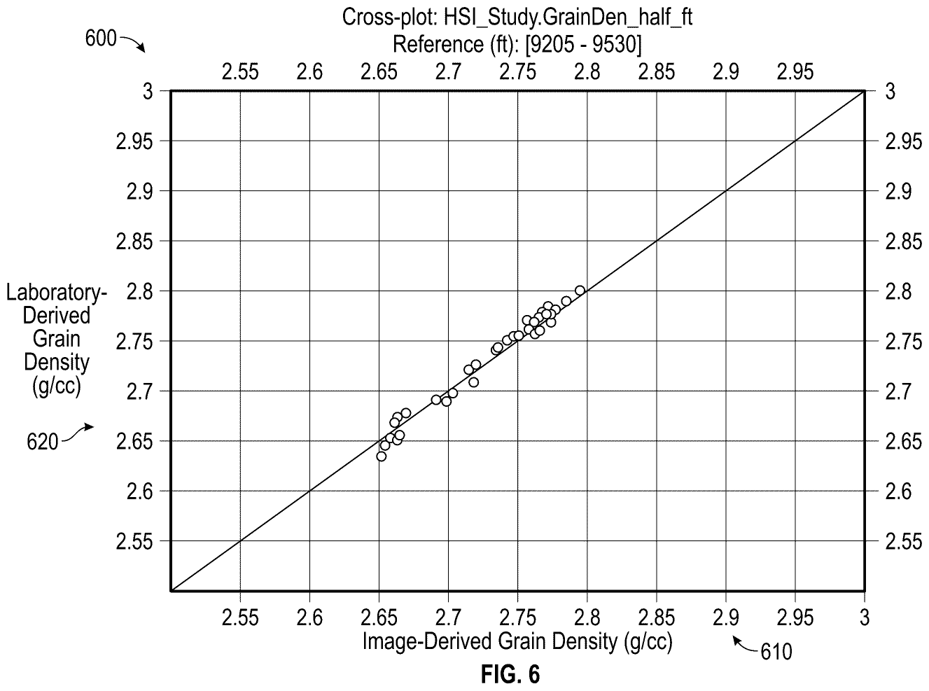

The method of determining an image-derived grain density (530) described above differs significantly from the laboratory methods used to measure grain density described earlier. Nonetheless, image-derived grain density is generally accurate. FIG. 6 presents a grain density calibration cross-plot (600) for an exemplary embodiment of the present disclosure. The x-axis corresponds to the image-derived distribution of grain density (in g/cm³ or g/cc) (610), while the y-axis corresponds to measurements of grain density obtained in a laboratory (or a laboratory-derived distribution of grain density) (620) in the same units. The laboratory-derived distribution of grain density may be obtained in a laboratory following the methods described earlier using a physical sample of the well core. The diagonal line represents a 1:1 relationship in which the image-derived distribution of grain density is perfectly correlated with the laboratory derived distribution of grain density. As can be seen by the data points, the relationship closely follows the 1:1 diagonal line with slight deviations. Moreover, in one or more embodiments, the image-derived grain density (530) may be calibrated to improve the accuracy and obtain a calibrated distribution of grain density. If the image-derived grain density (610) differed significantly from the laboratory-derived grain density (620), then a correction could be applied to adjust the image-derived grain density (610) to bring the measurements into agreement. The correction may be determined via linear regression or by any other suitable mathematical technique. It is to be understood that the example provided in FIG. 6 is provided only for illustrative purposes and is not to be considered limiting. Different relationships between the image-derived distribution of grain density and laboratory-derived distribution of grain density may be observed, and each may require its own calibration. After a calibration is applied, the image-derived distribution of grain density may be said to be a calibrated distribution of grain density.

In accordance with one or more embodiments, a vertical profile of grain density may be determined across the well core using the calibrated distribution of grain density. As mentioned previously, one of the strengths of the methods and systems described in the present disclosure is that unlike laboratory methods for measuring grain density, which are discrete and localized to only small regions of the well core, the calibrated distribution of grain density obtained from the hyperspectral image quantifies the grain density at every position on the well core. The vertical profile of grain density quantifies the average or median (or another summary statistic) grain density as a function of vertical depth in the well or position on the well core. In one or more embodiments, the vertical profile of grain density may be determined by sampling the calibrated distribution of grain density across a predetermined physical scale. For example, in one or more embodiments, a predetermined physical scale of 0.2 ft may be used to determine the vertical profile of grain density. In such an example, samples of the calibrated distribution of grain density would then be obtained across a predetermined physical scale of 0.2 ft, and the average or median grain density would be determined for each sample. Additional predetermined physical scales may be used, such as 0.5 ft, 1 ft, 2 ft, 10 ft, for example, to sample the calibrated distribution of grain density.

In accordance with one or more embodiments, a total porosity of the planned well, from which the well core originated, may be determined using the vertical profile of grain density. Recall that the total porosity of the subsurface region through which the planned well and drilled well core traverses is a function of both the bulk density of the subsurface region, the fluid density, and the grain density. The porosity that is determined in this way may be referred to as the “total” porosity because it accounts for all of the material in the subsurface region (i.e., bulk rock, fluid, and grains). The methods and systems of the present disclosure have explained how the grain density, as quantified by the vertical profile of grain density, is determined using a hyperspectral scanning image of the well core. What is needed to determine the total porosity then are the measurements of bulk density and fluid density. Measurements of bulk density and fluid density may be obtained according to any method known in the art. For example, as previously described, bulk density and fluid density can be measured through a variety of techniques applied in well logging, including measurement of the attenuation of gamma rays, resistivity, as well as seismic and acoustic analysis. The total porosity, φₜ, is given by the following equation:

$${φ}_{t} = \frac{( {ρ}_{grain} - {ρ}_{bulk} )}{( {ρ}_{grain} - {ρ}_{fluid} )} . \qquad ( 4 )$$

Here, ρ_{grain} is again the grain density, ρ_{bulk} is the bulk density, and ρ_{fluid} is the fluid density.

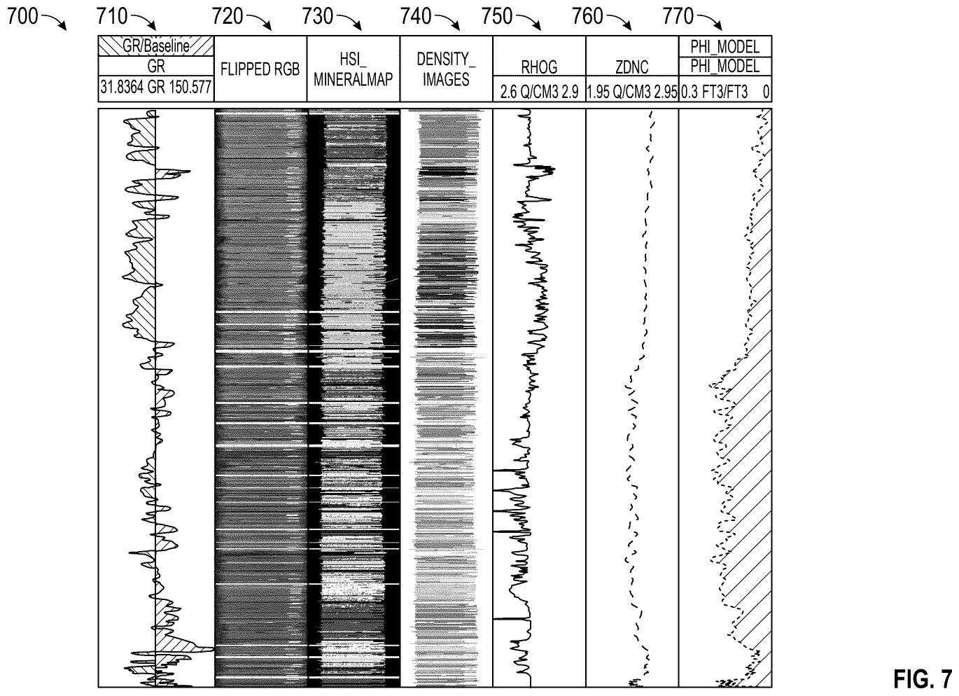

In one or more embodiments, the vertical profile of grain density is combined with well logs of the planned well. An example of such an embodiment, that is, an integration with well logs (700), is provided in FIG. 7. The integration with well logs (700) may include measurements of gamma ray logs (710), a flipped RGB image (720) obtained from the well core (e.g., obtained from core scanning (230) in the preliminary workflow (200)), a hyperspectral imaging mineral map (730) (elsewhere referred to as a distribution of mineral abundance), density images (740) (elsewhere referred to as a distribution of grain density), the vertical profile of grain density (750), well core bulk density (760) of material within the subsurface region traversed by the well, and a model of the total porosity (770), φₜ, within the well. For each column of data (710-770), the vertical axis represents depth. Thus, each of the measurements (710-770) has been aligned across depth and therefore across the well core. Again, the total porosity in the case of the integration with well logs (700) may determined from combining the vertical profile of grain density (750) with the measurements of bulk density (760), as well as a measurement of the fluid density (not shown), using EQ. 4 above.

It is to be understood that FIG. 7 represents only one possible embodiment of the present disclosure. Any measurement that provides an estimate of the bulk density and the fluid density may be utilized in conjunction with the vertical profile of grain density that is determined by the methods and systems of the present disclosure in order to determine a total porosity.

As demonstrated above, the methods and systems of the present disclosure allow for the total porosity to be measured at any depth and at any physical scale across the well core. In a planned well, for example, the total porosity at different depths may be used to determine the appropriate depths or layers within the subsurface region for further drilling, or for other modifications. However, in some instances, only the average total porosity of the well core may need to be estimated. In one or more embodiments, a portion of the planned well may be updated, using a well planning system, based on the total porosity. Porosity is frequently used in ascertaining rock quality, both in terms of flow efficiency and storage As previously described, regions of high porosity are likely to contain subsurface fluids such as oil and gas, while regions of low porosity are less likely. In one or more embodiments, updating the portion of the planned well involves using the well planning system to adjust the path of the planned well to target a subsurface region with a predetermined total porosity, and the adjustment is made based on the determined total porosity of the planned well. That is, because the total porosity is known across the well core, any predetermined total porosity may be identified, and the path of a portion of the planned well may be updated to target a region (or multiple regions) with the predetermined total porosity. In other embodiments, the total porosity may be used to inform oil and gas reserve estimation, cementing procedures, perforation, and other production decisions. For example, in reserve estimation, the total volumes of subsurface gas and oil are assumed to be linearly proportional to the determined porosity. In addition, a common practice in well planning is comparing similar wells and subsurface regions to each other. Detailed and reliable measurements of porosity therefore support knowledge transfer by enabling useful comparisons between wells.

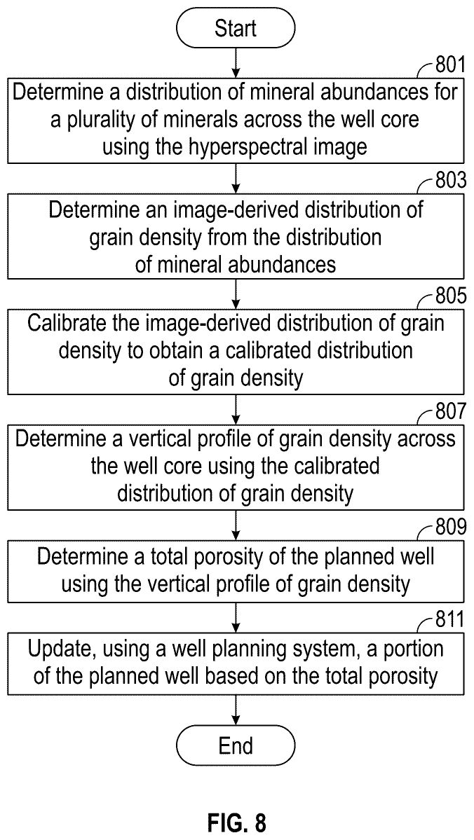

In accordance with one or more embodiments, FIG. 8 depicts a flowchart outlining the steps to update a well plan for a planned well using a hyperspectral image of a well core obtained from the planned well. In Block 801, a distribution of mineral abundances may be determined for a plurality of minerals across the well core using the hyperspectral image. Various examples have been given above explaining how a distribution of mineral abundances can be determined from a hyperspectral image. Each method relies on the spectra contained by each pixel of the hyperspectral image, and the methods exploit the unique spectral signatures of different minerals. Specific examples of machine learning methods, such as a neural network and a self-organizing map have been provided as well, although embodiments of the present disclosure are not limited exclusively to methods involving machine learning.

In Block 803, an image-derived distribution of grain density may be determined from the distribution of mineral abundances. The distribution of mineral abundances describes the presence of minerals in each pixel of the hyperspectral image. As previously described, the relative volumetric concentration of each mineral can be estimated in various ways, for example, by counting the number of pixels belonging to each mineral type in a sliding window function. As the densities of each mineral that may be present are known quantities, the image-derived distribution of grain densities can be determined by multiplying the number of pixels belonging to the mineral type by the mineral's density and dividing by the total number of pixels. This operation may repeat across each position of the sliding window function. Additional methods for determining the image-derived distribution of grain density may be considered as well. For example, a machine learning model may be trained to not only classify minerals but also determine their contribution to the grain density.

In Block 805, the image-derived distribution of grain density may be calibrated to obtain a calibrated distribution of grain density. Standard methods for measuring grain density rely on destructive laboratory methods utilizing physical samples extracted from well cores. Although these measurements are localized and discrete, they are nonetheless accurate and may be used as a reference “ground truth” in evaluating the image-derived distribution of grain density. In addition, these laboratory-derived distributions of grain density may be used to calibrate the image-derived distribution of grain density. Any disagreement between the laboratory-derived distribution of grain density and the image-derived distribution of grain density may be corrected through determining a correction factor via mathematical modeling techniques like linear regression, or polynomial fitting.

In Block 807, a vertical profile of grain density may be determined across the well core using the calibrated distribution of grain density. The calibrated distribution of grain density quantifies the grain density of the well core at each position of the well core. Therefore, the vertical profile of grain density may be determined by considering different physical scales across the well core and determining the average or median grain density by sampling different regions.

In Block 809, a total porosity of the planned well may be determined using the vertical profile of grain density. As previously described, the total porosity is a function of the grain density, the bulk density, and the fluid density. Measurements of the bulk density and fluid density may be determined using any known method in the art including those commonly applied in well logging. In one or more embodiments, determining the total porosity involves combining the vertical profile of grain density with well logs of the planned well. The well logs may include measurements a bulk density of material within the planned well as well as measurements of fluid density. The total porosity may then be determined by calculating a weighted average of density within the planned well using the bulk density and fluid density from the well logs as well as the vertical profile of grain density.

In Block 811, a portion of the planned well may be updated using a well planning system and based on the total porosity of the planned well. Description of a well planning system has been given above in relation to FIG. 1. The total porosity may be informative for a number of operations related to updating planned wells, including drilling operations, cementing procedures, perforation, injection, production, and overall well management. In one or more embodiments, the well planning system may be used to adjust the path of the planned well to target a subsurface region with a predetermined total porosity. The adjustment, in this case, is made based on the determined total porosity of the planned well which may indicate which subsurface regions exhibit the predetermined total porosity.

Embodiments of the present disclosure may provide at least one of the following advantages. First, the total porosity is determined at a great resolution from the vertical profile of grain density thus providing measurements across a range of physical scales that span the entirety of drilled well cores. The entirety of the drilled well core may then be analyzed by production engineer. By contrast, standard methods for measuring grain density, and consequently total porosity, are discrete and local to only the locations from where physical samples are obtained from the well core. Consequently, not only is the measurement of total porosity provided by the methods and systems of the present disclosure more spatially resolved but it is more accurate. In addition, the methods and systems of the present disclosure are non-destructive to physical samples of the well core. Although the image-derived distribution of grain density may be calibrated using physical samples from the well core, in principle this step could be performed only once. After the calibration is determined, no physical samples are then needed. Further, the methods and systems of the present disclosure are fast and affordable, requiring primarily a hyperspectral image. Moreover, the methods and systems of the present disclosure are widely applicable, as many wells have cores drilled from them.

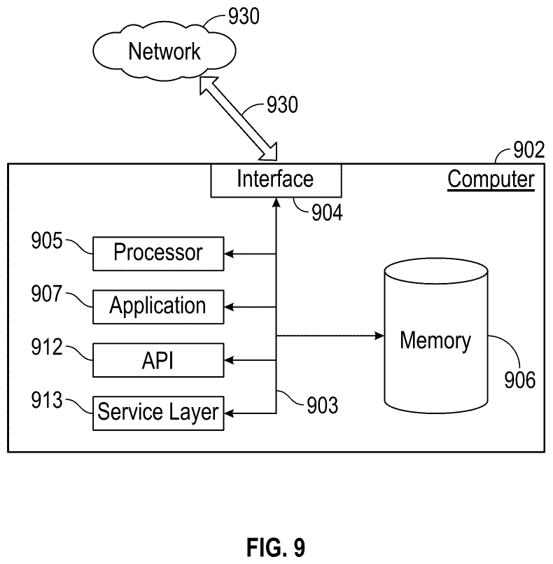

FIG. 9 further depicts a block diagram of a computer system (902) (e.g., the pressure control system) used to provide computational functionalities associated with the methods, functions, processes, flows, and procedures as described in this disclosure, according to one or more embodiments. The illustrated computer (902) is intended to encompass any computing device such as a server, desktop computer, laptop/notebook computer, wireless data port, smart phone, personal data assistant (PDA), tablet computing device, one or more processors within these devices, or any other suitable processing device, including both physical or virtual instances (or both) of the computing device. Additionally, the computer (902) may include a computer that includes an input device, such as a keypad, keyboard, touch screen, or other device that can accept user information, and an output device that conveys information associated with the operation of the computer (902), including digital data, visual, or audio information (or a combination of information), or a GUI.

The computer (902) can serve in a role as a client, network component, a server, a database or other persistency, or any other component (or a combination of roles) of a computer system for performing the subject matter described in the instant disclosure. In some implementations, one or more components of the computer (902) may be configured to operate within environments, including cloud-computing-based, local, global, or other environment (or a combination of environments).

At a high level, the computer (902) is an electronic computing device operable to receive, transmit, process, store, or manage data and information associated with the described subject matter. According to some implementations, the computer (902) may also include or be communicably coupled with an application server, e-mail server, web server, caching server, streaming data server, business intelligence (BI) server, or other server (or a combination of servers).

The computer (902) can receive requests over network (930) from a client application (for example, executing on another computer (902) and responding to the received requests by processing the said requests in an appropriate software application. In addition, requests may also be sent to the computer (902) from internal users (for example, from a command console or by other appropriate access method), external or third-parties, other automated applications, as well as any other appropriate entities, individuals, systems, or computers.

Each of the components of the computer (902) can communicate using a system bus (903). In some implementations, any or all of the components of the computer (902), both hardware or software (or a combination of hardware and software), may interface with each other or the interface (904) (or a combination of both) over the system bus (903) using an application programming interface (API) (912) or a service layer (913) (or a combination of the API (912) and service layer (913). The API (912) may include specifications for routines, data structures, and object classes. The API (912) may be either computer-language independent or dependent and refer to a complete interface, a single function, or even a set of APIs. The service layer (913) provides software services to the computer (902) or other components (whether or not illustrated) that are communicably coupled to the computer (902). The functionality of the computer (902) may be accessible for all service consumers using this service layer. Software services, such as those provided by the service layer (913), provide reusable, defined business functionalities through a defined interface. For example, the interface may be software written in JAVA, C++, or other suitable language providing data in extensible markup language (XML) format or another suitable format. While illustrated as an integrated component of the computer (902), alternative implementations may illustrate the API (912) or the service layer (913) as stand-alone components in relation to other components of the computer (902) or other components (whether or not illustrated) that are communicably coupled to the computer (902). Moreover, any or all parts of the API (912) or the service layer (913) may be implemented as child or sub-modules of another software module, enterprise application, or hardware module without departing from the scope of this disclosure.

The computer (902) includes an interface (904). Although illustrated as a single interface (904) in FIG. 9, two or more interfaces (904) may be used according to particular needs, desires, or particular implementations of the computer (902). The interface (904) is used by the computer (902) for communicating with other systems in a distributed environment that are connected to the network (930). Generally, the interface (904) includes logic encoded in software or hardware (or a combination of software and hardware) and operable to communicate with the network (930). More specifically, the interface (904) may include software supporting one or more communication protocols associated with communications such that the network (930) or interface's hardware is operable to communicate physical signals within and outside of the illustrated computer (902).

The computer (902) includes at least one computer processor (905). Although illustrated as a single computer processor (905) in FIG. 9, two or more processors may be used according to particular needs, desires, or particular implementations of the computer (902). Generally, the computer processor (905) executes instructions and manipulates data to perform the operations of the computer (902) and any algorithms, methods, functions, processes, flows, and procedures as described in the instant disclosure.

The computer (902) also includes a memory (906) that holds data for the computer (902) or other components (or a combination of both) that can be connected to the network (930). The memory may be a non-transitory computer readable medium. For example, memory (906) can be a database storing data consistent with this disclosure. Although illustrated as a single memory (906) in FIG. 9, two or more memories may be used according to particular needs, desires, or particular implementations of the computer (902) and the described functionality. While memory (906) is illustrated as an integral component of the computer (902), in alternative implementations, memory (906) can be external to the computer (902).

The application (907) is an algorithmic software engine providing functionality according to particular needs, desires, or particular implementations of the computer (902), particularly with respect to functionality described in this disclosure. For example, application (907) can serve as one or more components, modules, applications, etc. Further, although illustrated as a single application (907), the application (907) may be implemented as multiple applications (907) on the computer (902). In addition, although illustrated as integral to the computer (902), in alternative implementations, the application (907) can be external to the computer (902).

There may be any number of computers (902) associated with, or external to, a computer system containing computer (902), wherein each computer (902) communicates over network (930). Further, the term “client,” “user,” and other appropriate terminology may be used interchangeably as appropriate without departing from the scope of this disclosure. Moreover, this disclosure contemplates that many users may use one computer (902), or that one user may use multiple computers (902).

Although only a few example embodiments have been described in detail above, those skilled in the art will readily appreciate that many modifications are possible in the example embodiments without materially departing from this invention. Accordingly, all such modifications are intended to be included within the scope of this disclosure as defined in the following claims.

What is claimed is:

1. A method of updating a well plan for a planned well, using a hyperspectral image of a well core obtained from the planned well, the method comprising:
determining a distribution of mineral abundances for a plurality of minerals across the well core using the hyperspectral image;
determining an image-derived distribution of grain density from the distribution of mineral abundances;
calibrating the image-derived distribution of grain density to obtain a calibrated distribution of grain density;
determining a vertical profile of grain density across the well core using the calibrated distribution of grain density;
determining a total porosity of the planned well using the vertical profile of grain density; and
updating, using a well planning system, a portion of the planned well based on the total porosity.

2. The method of claim 1, wherein determining the distribution of mineral abundances comprises classifying a spectral response from the hyperspectral image using a self-organizing map.

3. The method of claim 1, wherein determining the distribution of grain density comprises modifying the distribution of mineral abundances according to a known density of each mineral in the plurality of minerals.

4. The method of claim 1, wherein calibrating the image-derived distribution of grain density comprises adjusting the image-derived distribution of grain density based on a laboratory-derived distribution of grain density obtained from a physical sample of the well core.

5. The method of claim 1, wherein determining the vertical profile of grain density comprises sampling the calibrated distribution of grain density across a predetermined physical scale.

6. The method of claim 1, wherein determining the total porosity of the planned well comprises:
combining the vertical profile of grain density with well logs of the planned well, the well logs comprising a bulk density of material within the planned well; and
determining a weighted average of density within the planned well using the bulk density from the well logs and the vertical profile of grain density.

7. The method of claim 1, wherein updating the portion of the planned well comprises using the well planning system to adjust a path of the planned well to target a subsurface region with a predetermined total porosity, wherein the adjustment is made based on the determined total porosity of the planned well.

8. A system for updating a well plan for a planned well, using a hyperspectral image of a well core obtained from the planned well, the system comprising:
a computer configured to:
determine a distribution of mineral abundances for a plurality of minerals across the well core using the hyperspectral image;
determine an image-derived distribution of grain density from the distribution of mineral abundances;
calibrate the image-derived distribution of grain density to obtain a calibrated distribution of grain density;
determine a vertical profile of grain density across the well core using the calibrated distribution of grain density; and
determine a total porosity of the planned well using the vertical profile of grain density; and
a well planning system configured to update a portion of the planned well based on the total porosity.

9. The system of claim 8, wherein determining the distribution of grain density comprises modifying the distribution of mineral abundances according to a known density of each mineral in the plurality of minerals.

10. The system of claim 8, wherein calibrating the image-derived distribution of grain density comprises adjusting the image-derived distribution of grain density based on a laboratory-derived distribution of grain density obtained from a physical sample of the well core.

11. The system of claim 8, wherein determining the vertical profile of grain density comprises sampling the calibrated distribution of grain density across a predetermined physical scale.

12. The system of claim 8, wherein determining the total porosity of the planned well comprises:
combining the vertical profile of grain density with well logs of the planned well, the well logs comprising a bulk density of material within the planned well; and
determining a weighted average of density within the planned well using the bulk density from the well logs and the vertical profile of grain density.

13. The system of claim 8, wherein updating the portion of the planned well comprises using the well planning system to adjust a path of the planned well to target a subsurface region with a predetermined total porosity, wherein the adjustment is made based on the determined total porosity of the planned well.

14. A non-transitory computer-readable memory comprising computer-executable instructions stored thereon that, when executed on a processor, cause the processor to update a well plan for a planned well, using a hyperspectral image of a well core obtained from the planned well, by performing:
determining a distribution of mineral abundances for a plurality of minerals across the well core using the hyperspectral image;
determining an image-derived distribution of grain density from the distribution of mineral abundances;
calibrating the image-derived distribution of grain density to obtain a calibrated distribution of grain density;
determining a vertical profile of grain density across the well core using the calibrated distribution of grain density;
determining a total porosity of the planned well using the vertical profile of grain density; and
updating, using a well planning system, a portion of the planned well based on the total porosity.

15. The non-transitory computer-readable memory of claim 14, wherein determining the distribution of mineral abundances comprises classifying a spectral response from the hyperspectral image using a self-organizing map.

16. The non-transitory computer-readable memory of claim 14, wherein determining the distribution of grain density comprises modifying the distribution of mineral abundances according to a known density of each mineral in the plurality of minerals.

17. The non-transitory computer-readable memory of claim 14, wherein calibrating the image-derived distribution of grain density comprises adjusting the image-derived distribution of grain density based on a laboratory-derived distribution of grain density obtained from a physical sample of the well core.

18. The non-transitory computer-readable memory of claim 14, wherein determining the vertical profile of grain density comprises sampling the calibrated distribution of grain density across a predetermined physical scale.

19. The non-transitory computer-readable memory of claim 14, wherein determining the total porosity of the planned well comprises:
combining the vertical profile of grain density with well logs of the planned well, the well logs comprising a bulk density of material within the planned well; and
determining a weighted average of density within the planned well using the bulk density from the well logs and the vertical profile of grain density.

20. The non-transitory computer-readable memory of claim 14, wherein updating the portion of the planned well comprises using the well planning system to adjust a path of the planned well to target a subsurface region with a predetermined total porosity, wherein the adjustment is made based on the determined total porosity of the planned well.
